(19) United States
(12) Patent Application Publication
(10) Pub. No.: US 2026/0236870 A1
(43) Pub. Date: Aug. 13, 2026

(54) RISK ASSESSMENT SCORING FOR WATER TREATMENT SYSTEMS

(71) Applicant: Evoqua Water Technologies LLC, Pittsburgh, PA (US)

(72) Inventors: Scott Branum, Birmingham, AL (US); Forest Sears, Pittsburgh, PA (US)

(21) Appl. No.: 19/157,518

(22) PCT Filed: Feb. 16, 2024
(86) PCT No.: PCT/US2024/016131

§ 371 Date: Aug. 18, 2025

Related U.S. Application Data
(60) Provisional application No. 63/446,063, filed on Feb. 16, 2023.

(51) Int. Cl. G06Q 10/0635; C02F 1/32; C02F 1/42; C02F 1/44; G06Q 10/04; G06Q 10/0637; G06Q 50/06

(52) U.S. Cl. CPC G06Q 10/0635; C02F 1/32; C02F 1/42; C02F 1/441; C02F 1/444; G06Q 10/04; G06Q 10/0637; G06Q 50/06; C02F 2209/001; C02F 2209/003; C02F 2209/02; C02F 2209/03; C02F 2209/05; C02F 2209/20; C02F 2209/22; C02F 2209/24; C02F 2209/40; C02F 2209/42

(57) ABSTRACT

A method of treating water in a water treatment system comprises introducing water to be treated into the water treatment system to produce a defined quantity of treated water having a defined quality metrics, receiving data indicative of one or more operating parameters of one or more unit operations of the water treatment system, determining a probability that the water treatment system will be able to produce and maintain production of treated water meeting the defined quality and the defined quantity metrics based on the received data, generating a risk assessment score based on the probability, and displaying the risk assessment score to a user.

### CROSS-REFERENCE TO RELATED APPLICATIONS

This application is a U.S. National Stage entry of International Patent Application No. PCT/US2024/016131 filed Feb. 16, 2024, which claims priority 35 U.S.C. § 119(e) to U.S. Provisional Patent Application Ser. No. 63/446,063 filed Feb. 16, 2023, each of which are incorporated herein by reference in their entirety for all purposes.

### BACKGROUND

### Field of Disclosure

Aspects and embodiments disclosed herein are directed generally to methods and apparatus for monitoring water treatment systems, calculating the probability of meeting water quality requirements, calculating a risk assessment score, and for generating and providing recommended actions to take to mitigate potential risks.

### Discussion of Related Art

In many industries, ensuring that a water treatment system is capable of meeting quality and quantity requirements is of the great importance. While this is particularly important to pharmaceutical companies using validated systems, the same concerns exist in other industries such as food and beverage, vitamin manufacturing, health care, and others. A system that is unable to meet water quality and quantity requirements often impacts production, leads to rework, and additional increases to cost. For some implementations, the risks include impact to the end users, liability or in the most extreme cases, work related accidents. Current approaches to managing these types of risk fall into two primary classes: Preventative and reactive. Preventative mitigation often includes scheduled or routine maintenance, including but not limited to system sanitization. Reactive mitigation often includes action performed as a result of detected failure, including but not limited to biological culture counts. Proactive mitigation can result in unnecessary costs, while reactive mitigation often leads to unplanned action impacting overall cost or the reduction in system availability. In both instances, the user is often managing the water system with limited or untimely information. Biological culture counts, for example, can take up to five days before data is available.

Treated water is typically used in the production and cleaning of products that are used in the health care industry. In one example, water treatment for the pharmaceutical or pseudo-pharma industries is a large market both in the United States and also worldwide. The water needed for pharmaceutical uses include, for example, water needed for rinsing or washing and purified water for preparation of pharmaceuticals (such as, e.g., topical ointment) to water for injection. The entire lifecycle of these systems, from RFQ (Request for Quote) to end of life cycle is focused on managing or mitigating the risks associated with poor water quality. These water treatment systems can be very complex, often including pre-treatment, process, storage, and recirculation equipment. Pharmaceutical products manufacturers who own water treatment systems often have limited internal expertise or resources available for life cycle management. To compensate for this knowledge deficiency, such manufacturers may rely on scheduled sanitization, excessive manual testing, reliance on inference data or some combination thereof. In some instances, some have been observed sanitizing a water treatment system every single day.

### SUMMARY

In accordance with one aspect, there is provided a method of treating water in a water treatment system. The method comprises introducing water to be treated into the water treatment system to produce a defined quantity of treated water having a defined quality metrics, receiving data indicative of one or more operating parameters of one or more unit operations of the water treatment system, determining a probability that the water treatment system will be able to produce and maintain production of treated water meeting the defined quality and the defined quantity metrics based on the received data, generating a risk assessment score based on the probability, and displaying the risk assessment score to a user.

In some embodiments, the method further includes providing an indication of a confidence level of the risk assessment score.

In some embodiments, the method further includes determining the confidence level based on historical data regarding instances of the water treatment system providing treated water meeting or not meeting the defined quality and quantity metrics and levels of the one or more operating parameters at times of the instances.

In some embodiments, the method further comprises providing a recommended action to take to mitigate a predicted change in quality of the treated water.

In some embodiments, the method further includes determining the recommended action based on historical data regarding instances of the water treatment system providing treated water meeting or not meeting the defined quality metrics, levels of the one or more operating parameters at times of the instances, and actions taken to bring the water treatment system into a condition in which it again provided treated water meeting the defined quality metrics.

In some embodiments, the method further comprises providing a recommended action to take to improve the risk assessment score.

In some embodiments, the method further includes determining the recommended action based on historical data regarding instances of the water treatment system exhibiting the risk assessment score, levels of the one or more operating parameters at times of the instances, and actions taken to improve the risk assessment score.

In some embodiments, the method further includes determining a recommended time to perform preventative maintenance on the water treatment system based on the data indicative of the one or more operating parameters and historical data regarding instances of the water treatment system providing treated water not meeting the defined quality metrics and levels of the one or more operating parameters at times of the instances.

In some embodiments, the method further includes displaying an indication of which of the one or more operating parameters are contributing to the risk assessment score being less than optimal.

In some embodiments, the method further includes using the risk assessment score as an input to train the artificial intelligence system.

In some embodiments, the method further includes incorporating the risk assessment score as an intrinsic component of a unique model architecture of the artificial intelligence system.

In some embodiments, the method further includes determining an effectiveness score for a preventative maintenance operation performed on the water treatment system and displays the effectiveness score to a user.

In some embodiments, the method further includes determining actions that could be taken to improve the effectiveness score and displays the actions to the user.

In some embodiments, the method further includes determining a potential overall impact of the actions to future effectiveness scores displays the overall impact to the user.

In some embodiments, the method further includes determining an index score for the water treatment system based on at least the data indicative of the one or more operating parameters.

In accordance with another aspect, there is provided a non-transitory computer-readable medium comprising code executable on a computer to implement any embodiments of the method disclosed herein.

In accordance with another aspect, there is provided a water treatment system including a controller programmed to perform any embodiments of the method disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates example data sources for an artificial intelligence system disclosed herein;

FIG. 2 is a flowchart of a method disclosed herein;

FIG. 3A is a schematic illustration of a water treatment system and associated monitoring system;

FIG. 3B is a schematic illustration of a water treatment system;

FIG. 4 is a schematic illustration of a water treatment system and associated monitoring system;

FIG. 5 is a schematic illustration of a data platform/monitoring system for a water treatment system;

FIG. 6 is an indication of primary components and key variables in one example of a water treatment system;

FIG. 7 illustrates an actual vs. target heating profile for an example of a heat sterilization process;

FIG. 8 illustrates an example of a user interface of a system as disclosed herein; and

FIG. 9 illustrates another example of a user interface of a system as disclosed herein.

### DETAILED DESCRIPTION

Aspects and embodiments disclosed herein are not limited to the details of construction and the arrangement of components set forth in the following description or illustrated in the drawings. Aspects and embodiments disclosed herein are capable of other embodiments and of being practiced or of being carried out in various ways.

Aspects and embodiments disclosed herein utilize artificial intelligence technology (AI) to calculate the probability of meeting water quality requirements and to calculate a risk assessment score for water treatment systems. The AI-calculated risk assessment score is a data derived value that provides a representation of a water system's current ability to meet water quality and quantity requirements. The risk assessment score may be a single value, for example, using a machine learning metric and providing a value such as, e.g., a letter grade of A through F summarizing the ability and probability of meeting water quality requirements.

Aspects and embodiments of the disclosed AI system aggregate multiple singular inputs into a risk assessment score and/or a water treatment system index score. The simple score allows a person to quickly evaluate the overall system performance relative to key business objectives. The overall health of the system can be represented by using AI to evaluate multiple variable inputs and outputs.

As the term is used herein the “health” of a water treatment system includes the probability or likelihood that a water treatment process system will meet or exceed the desired quality and quantity requirements of the customer as well as a data derived decision point of when performance is no longer acceptable, potentially impacting the water treatment system user's Total Cost of Ownership.

Aspects and embodiments of the system and method disclosed herein utilize AI to continually monitor available data and calculate a water treatment system risk assessment score. This allows for an end user of the water treatment system to easily understand the probability of the entire system to be able to produce the quality and quantity of water needed, within the set quality and quantity parameters. It also predicts the point in time that the system should receive preventative maintenance based on the AI tool using historical and current data.

Aspects and embodiments disclosed herein include a wireless monitoring system which enables data collection monitoring of the status of various meters, sensors, and scientific instruments at one or more locations. The data may be communicated wirelessly, for example, by means of the GSM cellular telephone network using a modem connected to a computer or a hand-held device, by Wi-Fi, or other wireless data collection methods known in the art, e.g., based on the LTE Cat 1, LTE Cat M1, or Cat NB1 standard. In other embodiments, data may be communicated via a wired connection to a centralized monitoring system.

Aspects and embodiments of the monitoring system may be utilized in the environment of a water treatment system. The water treatment system may include one or more unit operations. The one or more unit operations may include one or more pressure-driven water treatment devices, for example, membrane filtration devices such as nanofiltration (NF) devices, reverse osmosis (RO) devices, hollow fiber membrane filtration devices, etc., one or more ion-exchange water treatment devices, one or more electrically-driven water treatment devices, for example, electrodialysis (ED) or electrodeionization (EDI) devices, one or more chemical-based water treatment devices, for example, chlorination or other chemical dosing devices, one or more carbon filters, one or more biologically-based treatment devices, for example, aerobic biological treatment vessels, anaerobic digesters, or biofilters, one or more radiation-based water treatment devices, for example, ultraviolet light irradiation systems.

The monitoring system implements an artificial intelligence algorithm that determines the probability of a water treatment system meeting water quality requirements, calculates a risk assessment score for the water treatment system, and provides recommendations for avoiding or mitigating potential problems that might otherwise result in the water treatment system delivering water of unacceptable quality or quantity.

The water treatment system may be utilized to treat water for industrial uses, for example, for use in semiconductor processing plants, food processing or preparation sites, for use in chemical processing plants, to produce purified water for use as laboratory water, for medical device manufacturing, or pharmaceutical production, or may be utilized to provide a site with water suitable for irrigation or drinking water purposes. In other embodiments, the water treatment system may be utilized to treat wastewater from industrial or municipal sources.

The water treatment system may include one or more sensors, probes, or instruments for monitoring one or more parameters of water entering or exiting any one or more of the one or more unit operations of the water treatment system. The one or more sensors, probes, or instruments may include, for example, flow meters, water level sensors, conductivity meters, resistivity meters, chemical concentration meters, turbidity monitors, chemical species specific concentration sensors or analyzers, temperature sensors, pH sensors, oxidation-reduction potential (ORP) sensors, pressure sensors, power meters, vibration sensors, or any other sensor, probe, or scientific instrument useful for providing an indication of a desired characteristic or parameter of water entering or exiting any one or more of the one or more unit operations or of operating parameters of any one or more of the one or more unit operations, or any operating or parameter of any of the one or more unit operations of the water treatment system.

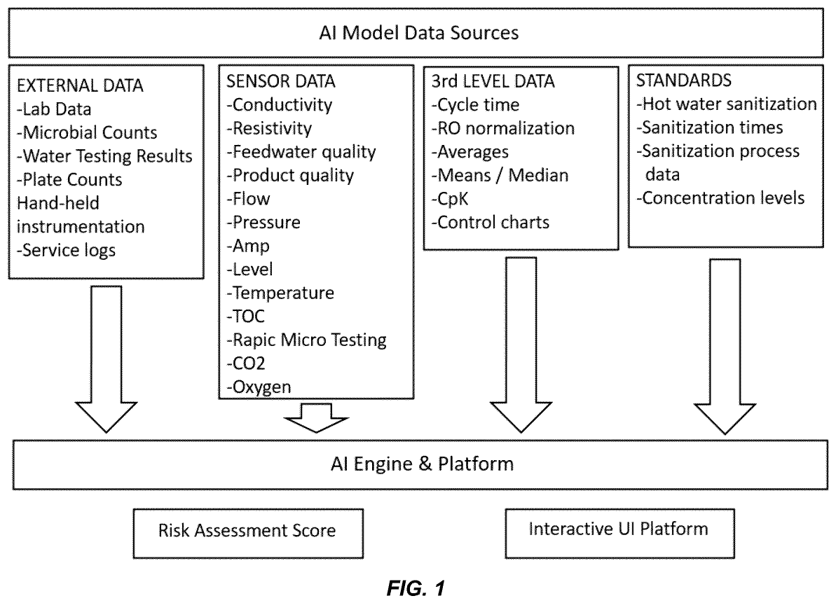

The parameters from any or all of these sensors, probes, or instruments can be analyzed to provide the probability of the water treatment system meeting water quality requirements, calculation of a risk assessment score for the water treatment system, and for determining and providing recommendations for actions to take to avoid or mitigate potential problems. The system may also be provided with data from external sources, for example, from laboratory analysis of water samples from water incoming to the system or treated water from the system and from service logs of prior maintenance or repair actions performed on the water treatment system, including indications of what types of service successfully addressed what types of problems, to include in its analysis. FIG. 1 presents an example of different data sources which may be utilized by the system as inputs. FIG. 1 has unstructured data sources (i.e., standards) and structured data sources (e.g., sensor data). In some embodiments, these different data sources can be warehoused in a data lake, which is a centralized repository that allows for the storage of vast amounts of structured, semi-structured, and unstructured data at any scale. Unlike traditional data storage systems that require data to be processed and structured before storage, a data lake stores raw data in its native format until it is needed for analysis or processing. This flexibility in data storage enables the accumulation of diverse data types from various sources without the need for upfront schema design or data transformation.

The monitoring system may be utilized to gather data from sensors, probes, or scientific instruments included in the water treatment system and may provide the gathered data to operators local to the water treatment system or to persons, for example, a water treatment system service provider, remote from the water treatment and monitoring system.

The monitoring system may include a computer system upon which is run an AI algorithm designed to provide an output in the form of a probability of a water treatment system meeting (or failing to meet) water quality requirements, a risk assessment score for the water treatment system, and operational recommendation(s) based on the prediction regarding the likelihood that the water treatment system may fail to continue to provide treated water of an acceptable quality and quantity.

The AI algorithm utilizes a blend of calculations which considers the data previously associated with the water treatment system unit operations as well as data pertaining to site conditions, for example, environmental conditions (for example, dry, wet, hot, or cold weather), time of year, geographical location, etc., at the time of all prior instances of conditions of interest, for example, out of control conditions or instances of poor water quality output, and customer use. The algorithm may modify the probability and risk scores based on historical data, for example, prior instances of equipment failure, out of control conditions, or instances of poor quality water output, for example, over the course of the last two years, combined with current state updates regarding feed water flow rate and data from the equipment probes and sensors as well as the other data sources disclosed herein. The current state updates may be processed periodically, for example, 12 times a day-every two hours, or continuously, or any other predefined interval. Periodic processing may use, e.g., batch processing, which works with large volumes of data collected over time and processed together, but not in real time. Batch processing is suitable for tasks where latency is not critical. On the other hand, continuous processing may use, e.g., real-time inference, which is capable of processing data as soon as it arrives, providing immediate responses or predictions. This results in short processing times and, thus, is appropriate for applications such as recommendation systems, real-time monitoring, etc. Data correlating instances of poor quality water excursions with one or more operation parameters of the unit operations of water treatment systems from other sites may also be used to modify the probability and risk score determinations, which may be useful for newly commissioned sites with little or no historical data. By using this algorithm, the incidents of quality excursions can be reduced and the cost of maintaining high quality water production while minimizing unnecessary service may be reduced.

Responsive to receiving an indication of a water quality alarm, embodiments of the disclosed system may provide the following recommended “actions” to operations personnel who are responsible for triaging alarms: “Create Service Order,” “No Action Required,” and “Monitor.” These recommendations may be based on factors such as historical data regarding conditions at the site when previous water quality alarms or service activities took place (time of year, environmental conditions, cumulative flow of feed water through one or more unit operations of the water treatment system, etc.) and whether the alarms indicated a true problem or were false alarms, current site water quality (e.g., conductivity) and flow rate conditions, and/or environmental conditions at the site, and/or time of year. Embodiments of the disclosed system may also output the “Prediction Accuracy %”—e.g., the level of confidence that the algorithm's prediction/recommendation is true. The algorithm makes this determination based on a combination of historical data such as that described above and data regarding the current state of system, including, for example, alarm status (active/restored) and changes in measured parameters of the feed water, treated water, and/or of the unit operations of the water treatment system.

Embodiments of the disclosed AI algorithm may assess all sites which are actively in an alarm state multiple times a day (e.g., 12 times/day). The AI algorithm interprets each new set of data gathered from each assessment during a day and determines if the overall recommended “action” should change or remain the same.

Based on analysis of the historical and current data from a site by embodiments of the AI algorithm, recommended actions of “No Action Required” or “Monitor” may either “Restore” (i.e., revert to normal state-“No Action Required”) or transition to “Create service order (SVO).” The specific recommended actions can be determined by, e.g., a recommender system.

In some embodiments, sites employing water treatment systems and their efficiencies are monitored by Digital Command Center Operations Specialists through mostly manual means with assistance from data reporting tools. When quality events are triggered, 100% are reviewed and a decision is made by the DCC Specialist to either create an SVO or monitor the system at which the alarm was triggered for a period. This process can take anywhere from, e.g., 1 minute to 10 minutes for the DCC Specialist to fully review and make the decision.

As the number of monitored sites continues to grow the number of full-time employees (FTEs) needed to review each site also increases. (FTE Assumption: 40 hrs a week*4 weeks=160 potential hours*0.7 (discount for 30% non-productivity time)=112 hrs of bandwidth for 1 FTE/1 Month)

Each decision to create an SVO or not has a mathematical calculation based on water treatment system configuration but in producing the ultimate decision, shortcuts may be taken due to human nature. Human judgment, given similar facts in two different scenarios, may produce different decisions. This variability results in inconsistent site configurations, over analysing, inconsistent results and ultimately less confidence in the appropriate action to take in response to a water quality alarm.

Developing a prediction model to move this decision-making process to a repeatable non-biased algorithm making consistent decisions continually learning from prior decisions (feedback) will ultimately produce more efficient sites. Service or maintenance activities will be performed with confidence at optimal times, freeing the DCC Specialists to review predefined gray areas to better train the model, further reducing anomalies. Being able to spend 10 minutes studying an anomaly is a better use of the Specialists' time than deciding how to react to every individual alarm condition.

Generation of the service or maintenance recommendation by the AI Algorithm may include development of a prediction model to determine the probability that service or maintenance at a given site is warranted based on quality events (e.g., water quality alarms), feed water flow and quality (e.g., conductivity), and an amount of water the system is expected to be able to treat prior to service or maintenance being warranted. The prediction/recommendation model will have three possible outcomes:
a. Create SVO—No site triage required. Conditions are such that the AI Algorithm has verified quality of water is degrading and service is recommended.
b. Monitor Sites—Possible site triage required. Conditions are in an area where the AI Algorithm needs more data to predict whether service is warranted or not.
c. No Action/Ignore—No site triage required. Conditions remaining favorable for a site to keep delivering quantity and quality of water for the customer.

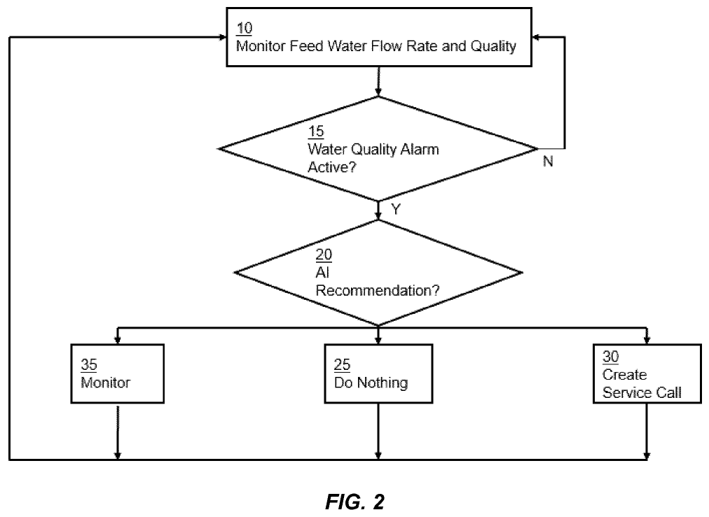

A flowchart of operation of one aspect of the AI algorithm is illustrated in FIG. 2. In act 10 the wastewater treatment system is operating normally and continuously or periodically monitoring the flow rate and quality, e.g., conductivity of feed water into the system or into a unit operation of the system. At act 15 a controller of the wastewater treatment system (local or remote) determines if a unit operation of the system is in an alarm state due to poor quality water exiting the unit operation, e.g., water with conductivity above a setpoint. If there is no water quality alarm, the method returns to monitoring the feed water flow rate and quality in act 10. If there is a water quality alarm, the AI algorithm determines how to respond (act 20). As discussed above, the AI algorithm may take into consideration historical data regarding previous alarms, service operations, and current conditions of feed water quality and flow rate as well as any of the other data discussed above into consideration to determine how to respond to the water quality alarm. If the AI algorithm determines that the alarm is a false alarm, it may provide a recommendation to do nothing (act 25), and the method returns to monitoring the feed water flow rate and quality in act 10. If the AI algorithm determines that the alarm indicates a true water quality alarm condition (or condition of imminent water quality degradation) it may provide a recommendation to perform a service operation and/or automatically generate a service call (act 25) which service personnel should follow before putting the wastewater treatment system back into service and returning to monitoring the feed water flow rate and quality in act 10. If the AI algorithm determines that the alarm condition may be a false alarm, for example, if false alarms occurred previously under similar conditions the AI algorithm may recommend entering a monitoring state (act 35) in which the feed water parameters and other operational parameters of the wastewater system are monitored even while the alarm is active. The monitoring state persists until either the alarm turns off, until the AI algorithm determines that the alarm is false and recommends doing nothing (act 25) or until the AI algorithm determines that the alarm indicates an actual state in which the system should be serviced (act 30).

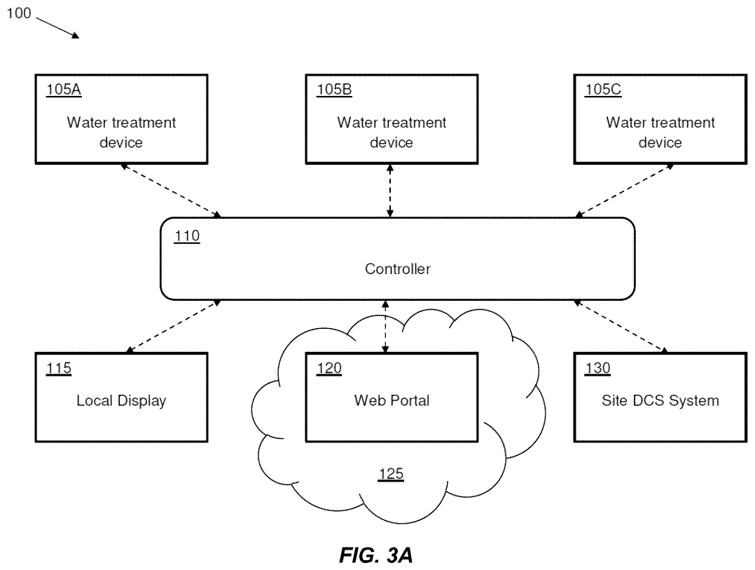

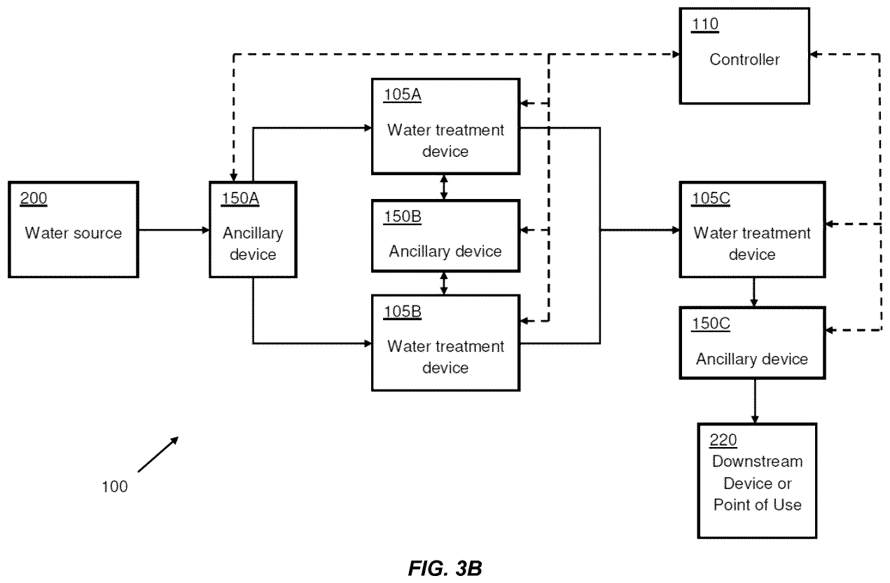

One embodiment of a water treatment system (also referred to herein as a water treatment unit) and associated monitoring system is illustrated schematically in FIG. 3A generally at 100. The water treatment system may include one or more water treatment units or devices 105A, 105B, 105C. The one or more water treatment devices may be arranged fluidically in series and/or in parallel as illustrated in FIG. 3B. Although only three water treatment devices 105A, 105B, 105C are illustrated, it is to be understood that the water treatment system may include any number of water treatment units or devices.

The water treatment system 100 may further include one or more ancillary systems 150A, 150B, 150C, for example, pumps, pre or post filters, polishing beds, heating or cooling units, sampling units, power supplies, or other ancillary equipment fluidically in line with or otherwise coupled to or in communication with the one or more water treatment units 105A, 105B, 105C. The ancillary systems are not limited to only three ancillary systems but may be any number and type of ancillary systems desired in a particular implementation. The one or more water treatment units 105A, 105B, 105C and ancillary systems 150A, 150B, 150C may be in communication with a controller 110, for example, a computerized controller, which may receive signals from and/or send signals to the one or more water treatment devices 105A, 105B, 105C and ancillary systems 150A, 150B, 150C to monitor and control same. The one or more water treatment devices 105A, 105B, 105C and ancillary systems 150A, 150B, 150C may send or receive data related to one or more operating parameters to or from the controller 110 in analog or digital signals. The controller 110 may be local to the water treatment system 100 or remote from the water treatment system 100 and may be in communication with the components of the water treatment system 100 by wired and/or wireless links, e.g., by a local area network or a data bus. A source of water to be treated 200 may supply water to be treated to the water treatment system 100. The water to be treated may pass through or be treated in any of the water treatment devices 105A, 105B, 105C and, optionally, one or more of the ancillary systems 150A, 150B, 150C and may be output to a downstream device or point of use 220. In some embodiments, the AI algorithm disclosed herein runs on the controller 110.

Returning to FIG. 3A, one or more sensors, probes, or scientific instruments associated with each of the water treatment devices 105A, 105B, 105C may be in communication, via a wired or a wireless connection, to a controller 110 which may include, for example, a local monitoring and data gathering device or system. The one of more sensors, probes or scientific instruments associated with each of the water treatment devices 105A, 105B, 105C may provide monitoring data to the controller 110 in the form of analog or digital signals. The controller 110 may provide data from the sensors or scientific instruments associated with each of the water treatment devices 105A, 105B, 105C to different locations. One of the locations may optionally include a display 115 local to one of the water treatment devices 105A, 105B, 105C or the site at which the water treatment devices 105A, 105B, 105C are located. Another of the locations may be a web portal 120 which may be hosted in a local or remote server or in the cloud 125. Another of the locations optionally may be a distributed control system (DCS) 130 which may be located at the site or at the facility at which the water treatment devices 105A, 105B, 105C are located. In some embodiments, the AI algorithm disclosed herein runs on the DCS 130 alternatively or in addition to the controller 110.

Processing of the data from the one or more sensors, probes, or scientific instruments associated with each of the water treatment devices 105A, 105B, 105C, as well as data from the other sources disclosed herein may be performed at the controller 110 and summarized data, including, for example, a risk assessment score and/or probability that the water treatment system will continue to produce treated water of the desired quality and quantity for the foreseeable future and/or a point in time that the system will likely need preventative maintenance, may be provided to one or more of the locations 115, 120, 130, or the controller 110 may pass raw data from the one or more sensors or scientific instruments or probes to one or more of the locations 115, 120, 130. The data may be available through one or more of the locations 115, 120, 130 to an operator of the water treatment system or any of the individual water treatment devices, to a user of treated water provided by the water treatment system, to a vendor or service provider that may be responsible for maintenance of one or more of the water treatment devices 105A, 105B, 105C or the system 100 as a whole, or to any other interested parties. For example, a user of the water treatment system 100 may access data related to water quality and/or quantity of treated water produced in the water treatment system 100 via the web portal 120 or via the site DCS system 130. The user may utilize such data for auditing purposes or to show compliance with regulations associated with production of the treated water. Further optional configurations contemplate storage of the raw or processed data or both at one or more data storage devices, at any of locations 110, 120 and 130.

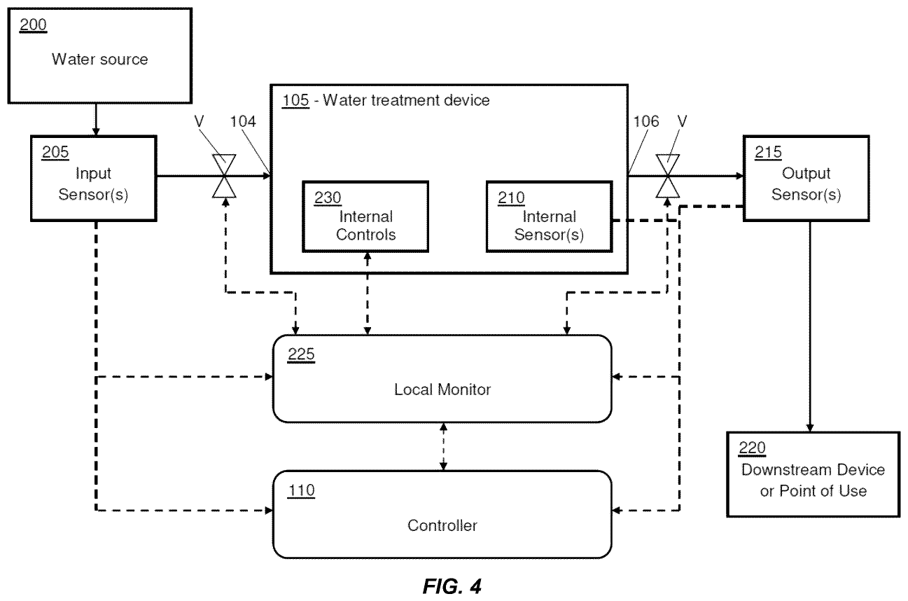

Features associated with the water treatment devices 105A, 105B, 105C are illustrated in FIG. 4, wherein an example of a water treatment device (which may be any one or more of water treatment devices 105A, 105B, 105C) is indicated at 105. A source 200 of water (alternatively referred to herein as feedwater) to be treated in the water treatment device 105 may be disposed in fluid communication upstream of the water treatment device 105. The source 200 may be a source of untreated water, water output from a plant or from a point of use at the site at which the water treatment device 105 is located, or an upstream water treatment device. The water to be treated may pass through or otherwise be monitored by one or more sensors 205 upstream of the inlet of the water treatment device 105. The one or more sensors 205 may include, for example, a flow meter, a conductivity sensor, a pH sensor, a turbidity sensor, a temperature sensor, a pressure sensor, an ORP sensor, or any one or more of the other forms of sensors described above. The one or more sensors 205 may provide data regarding one or more measured parameters of the water to be treated in the water treatment device 105 to a local monitor 225 associated with the water treatment device 105 which may pass the data on to the controller 110. The one or more sensors 205 may provide the data in either analog signals or digital signals. The local monitor 225 may be included as hardware or software in the controller 110 or may be a separate device. The one or more sensors 205 may additionally or alternatively provide data regarding the one or more measured parameters of the water to be treated in the water treatment device 105 directly to the controller 110. The local monitor 225 and/or controller 110 may also be in communication with any of the other sources of data disclosed herein, for example, any one or more of those indicated in FIG. 1.

The water to be treated may enter the water treatment device 105 through an inlet 104 of the water treatment device 105 and undergo treatment within the water treatment device 105. One or more sensors 210 may be disposed internal to the water treatment device 105 to gather data related to operation of the water treatment device 105 and/or one or more parameters of the water undergoing treatment in the water treatment device 105. The one or more sensors 210 may include, for example, a pressure sensor, level sensor, conductivity sensor, pH sensor, OPR sensor, current or voltage sensor, or any one or more of the other forms of sensors described above. The one or more sensors 210 may provide data related to operation of the water treatment device 105 and/or one or more parameters of the water undergoing treatment in the water treatment device 105 to the local monitor 225, which may pass the data on to the controller 110. The one or more sensors 210 may additionally or alternatively provide data related to operation of the water treatment device 105 and/or one or more parameters of the water undergoing treatment in the water treatment device 105 directly to the controller 110. Communications between the one or more sensors 210 and local monitor 225 and/or controller 110 may be via a wired or wireless communications link.

After treatment in the water treatment device 105 the treated water may exit though an outlet 106 of the water treatment device 105. One or more parameters of the treated water may be tested or monitored by one or more downstream sensors 215. The one or more sensors 215 may include, for example, a flow meter, a conductivity sensor, a pH sensor, a turbidity sensor, a temperature sensor, a pressure sensor, an ORP sensor, or any one or more of the other forms of sensors described above. The one or more sensors 215 may provide data regarding one or more measured parameters of the treated water to the local monitor 225, which may pass the data on to the controller 110. The one or more sensors 215 may additionally or alternatively provide data regarding the one or more measured parameters of the treated water directly to the controller 110. Communications between the one or more sensors 215 and local monitor 225 and/or controller 110 may be via a wired or wireless communications link. In some embodiments, the AI algorithm disclosed herein runs on the local monitor 225 alternatively to or in addition to the controller 110.

The local monitor 225 and/or controller 110 may include functionality for controlling the operation of the water treatment device 105. Based on measured parameters of the water to be treated or the treated water from the sensors 205 and/or 215, measured parameters from the one or more internal sensors 210, or based on a command received from an operator, the local monitor 225 and/or controller 110 may control inlet or outlet valves V (or one or more ancillary systems 150A, 150B, 150C illustrated in FIG. 2B) to adjust a flow rate or residence time of water within the water treatment device 105. The local monitor 225 and/or controller 110 may also control one or more internal controls 230 of the water treatment device 105 to adjust one or more operating parameters of the water treatment device 105, for example, internal temperature, pressure, pH, electrical current or voltage (for electrically-based treatment devices), aeration, mixing speed or intensity, or any other desired operating parameter of the water treatment device 105.

The local monitor 225 and/or controller 110 may monitor signals from one or more of the input sensors 205, internal sensors 210, and output sensors 215 to determine if an error condition or unexpected event has occurred and may be configured to generate and error message or signal in response to detecting same. For example, in instances in which the input sensors 205 and output sensors 215 include inlet and outlet pressure sensors, the local monitor 225 and/or controller 110 may be configured to receive inlet pressure data from the inlet pressure sensor and outlet pressure data from the outlet pressure sensor and generate an alarm if a difference in the pressure of the feedwater relative to the pressure of the treated water is above a differential pressure setpoint. In instances in which one or more of the input sensors 205, internal sensors 210, and output sensors 215 include a leak detection module disposed to close if moisture is detected in an enclosure of the water treatment unit 105, the local monitor 225 and/or controller 110 may be configured to generate an indication if the leak detection module detects moisture in the enclosure. In some embodiments, the leak detect module includes a sensor disposed externally or outside of but proximate the enclosure of the unit on a floor upon which the water treatment unit is set.

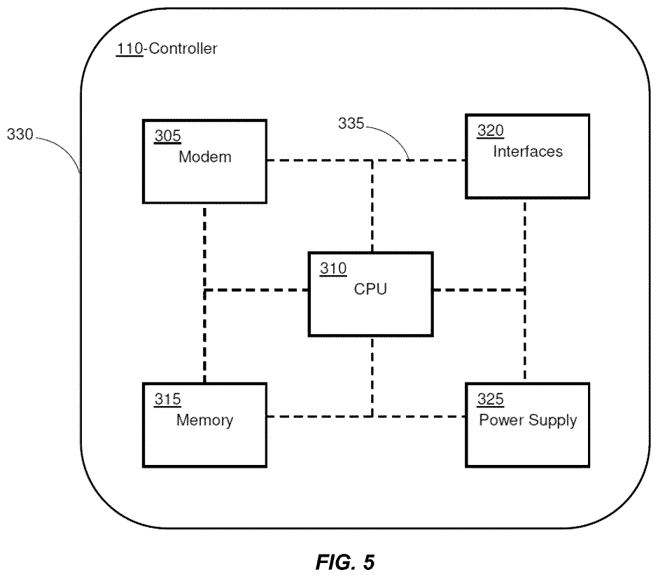

In one embodiment, the monitoring system, represented by the controller 110 and illustrated in further detail in FIG. 5, may include one or more wired and/or wireless communication modules, such as modem 305 which may, for example, utilize a cellular phone network, e.g., based on the LTE Cat 1, LTE Cat M1, or Cat NB1 standard, to communicate data regarding operation of a water treatment device 105 and/or water to be treated and/or water after being treated in a water treatment device 105 with a remote server or one of locations 115, 120, 130, a processing unit (CPU) 310 operatively connected to the communication modules, such as modem 305, a memory 315 operatively connected to the CPU 310 which could be used to store data received from sensors associated with the water treatment devices and/or code for controlling the operation of one or more water treatment devices, one or more additional interfaces 320, which may include wired or wireless (e.g., Wi-Fi, Bluetooth®, cellular, etc.) modules for connecting one or more scientific instruments or any of sensors 205, 210, 215 or other sensors associated with a water treatment device 105 or system to the central processing unit, a power supply 325 for providing electrical power to the modem 305 and the central processing unit, and an enclosure 330 for housing the components at the location. In some embodiments, the one or more module 305 may include a Bluetooth® interface operatively configured to wirelessly transmit data over a personal area network, e.g., a short distance network in compliance with the IEEE 802.15.1 standard, or a utilize wireless local area network protocols, e.g., Wi-Fi based on the IEEE 802.11 standard. In some embodiments, the one or more interfaces 320 may include a Bluetooth® interface operatively configured to wirelessly transmit data over a personal area network, e.g., a short distance network in compliance with the IEEE 802.15.1 standard, or a utilize wireless local area network protocols, e.g., Wi-Fi based on the IEEE 802.11 standard. Any or all of the components of the controller 110 may be communicatively coupled with one or more internal busses 335. In some embodiments, the memory 315 may include a non-transitory computer readable medium including instructions, that when executed by the CPU 310, cause the CPU 310 to perform any of the methods disclosed herein.

A variety of monitoring devices such as a flow meter or other scientific instrument are normally operably connected to the CPU 310 such that data from the monitoring device or scientific instrument is transmitted to the modem 305 where it can be accessed from a remote location through, for example, the cellular phone network.

In one aspect of the disclosure, a remote monitoring and control system architecture is used as illustrated in FIG. 3A. A controller 110 comprising a modem 305 (FIG. 5) and cellular connectivity is connected to various devices, for example, one or more sensors (for example, any one or more of sensors 205, 210, 215) associated with water treatment devices 105A, 105B, and 105C. The one or more sensors may comprise a service deionization tank resistivity monitor, a series of sensors and monitors such as a flow meter, conductivity meter, temperature and pH sensors for a water purification system such as a reverse osmosis system, or the one or more sensors may comprise a series of unit operations combined into a complete system. The information from the various one or more sensors is uploaded to internal portals from the operating business and can also be uploaded to customer portals and customer DCS systems 130. The entire network may be cloud based.

One example of a local water treatment system or unit 100 that may be included in aspects and embodiments disclosed herein includes a VRx and a SDRx water treatment system available from Evoqua Water Technologies LLC. Operation of the disclosed AI system will described with respect to this example treatment system, however, it is to be understood that this is only an illustrative example, and that the disclosed AI system may be utilized with any number of different water treatment systems with appropriate modifications, for example, to monitor particular parameters of concern for any particular water treatment system.

The VRx system includes two primary sub-systems. They are the pre-treatment make-up sub-system and the process treatment sub-system. The pre-treatment typically includes filtration, softening, chlorination and de-chlorination and ultraviolet (UV) light treatment. The process treatment sub-system typically includes reverse osmosis, UV, continuous deionization (CDI) and post micro-filtration.

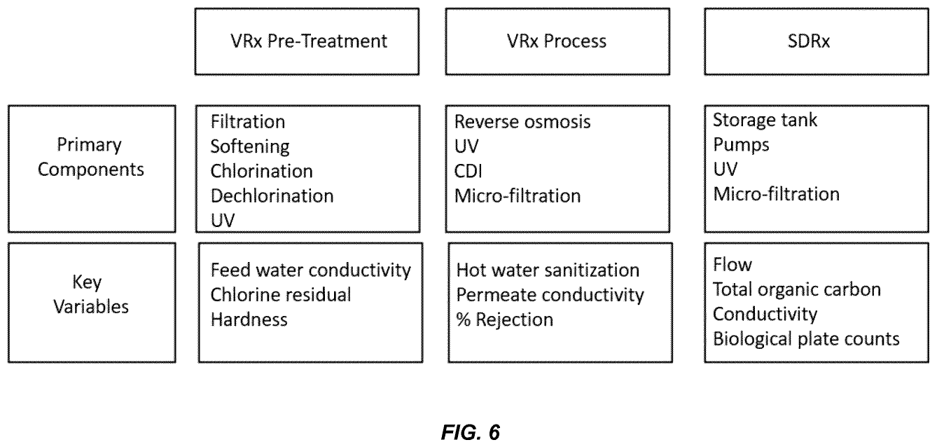

The SDRx system focuses on storage and distribution. It typically includes a storage tank, pumps, UV, and micro-filtration. Both the VRx and SDRx systems include a hot water sanitization process to control biological activity. Primary components and key variables of the VRx and SDRx systems are indicated in FIG. 6.

Currently, one of the primary health assessment tools for the VRx and SDRx systems is the use of biological plate counts. Typically, a customer will take periodic water samples from a point of use, or a recirculation loop if their water treatment system includes one, and culture them over a 48 to 72 hour time period to determine if biological cultures exist. Product, for example, a drug including treated water or a medical device having undergone sterilization using treated water, that has been made is normally quarantined, waiting on those results, before being shipped. If biological cultures are detected, the product may be scrapped or re-worked into future batches.

The biological plate count process is a lagging indicator of the quality of water used to manufacture product. More than likely, the indicators of poor or marginal quality existed in the water treatment process data. These are not easily identified for some of the following reasons:
Lack of internal expertise that is capable of gleaning insights from multi-variant sources of data.
Lack of knowledge about the inter-dependencies of the variable inputs and outputs.
No alarm or event has been generated by the process treatment systems. The water process systems are functioning, just not at an optimal level.
Alarms have been generated but the end user is not able to determine the root cause or an effective corrective action.

Leveraging AI, a multi-variant analysis would be able to look at the entire process, fully understanding the co-dependencies of all the inputs and outputs, process the overall health of a system, and its associated business risk, into a single score. The derived health score would not only provide an indication of the current level of manufacturing process risk, it would also suggest corrective actions that, once implemented, should improve the calculated score. The AI would also provide a summary of the variables or process that are influencing the score, driving awareness and proactive workflows.

### Hot Water Sanitizations Effectiveness Score

Most VRx and SDRx systems utilize a hot water sanitization (HWS) to control, reduce or eliminate biological activity. An “effectiveness scoring” of the HWS process, after it has been completed would allow a user to understand how well the sanitization was performed. In addition, recommendations would be provided as what could be changed to improve the score and its potential overall impact to future effectiveness scores. The Hot Water Sanitizations Effectiveness Score may stand on its own as the score serves as an indicator of how effective the most recent sanitization was. The Hot Water Sanitizations Effectiveness Score may also be incorporated as one of the regression analysis variables for the Index Score, discussed below.

For either sterilization or sanitization, there are two important parameters; time and temperature. For example, one skilled in the art would know that a terminal autoclave cycle comprises a temperature of at least 121° C. for a time of 15 minutes. This cycle has been shown to kill all microorganism. The cycle may be monitored by placing thermocouples in the autoclave to track the temperature. Often, a package of a known heat resistant bacteria such as a Bacillus species is placed in the autoclave and after the cycle cultured to see if bacteria will grow. A negative growth indicates a positive autoclave cycle.

A sanitization cycle also depends on time and temperature. It is understood by one skilled in the art that sanitization differs from sterilization in that sanitization is used to control bacterial growth and maintain the bacteria counts at an acceptable low level. Heat sanitization is recognized as being preferable to chemical sanitization since there is no chemical residue and there is no need to flush out a chemical after sanitization.

A typical HWS process includes the following steps:

| STEP | DESCRIPTION |
|---|---|
| 1 | Break tank quality rinse |
| 2 | System heat-up |
| 3 | System temperature hold |
| 4 | RO cooldown |
| 5 | CDI Cooldown |
| 6 | CDI quality rinse |
| 7 | Stand-by |

There are five primary system components that may be used for this analysis. Time and temperature data, at different steps in the process may be used to develop a HWS effectiveness score. The following steps and system locations may be monitored to develop the HWS effectiveness score:
A. Heat exchanger inlet
B. Heat exchanger outlet
C. RO Feedwater temperature
D. RO Product temperature
E. CDI Final Product temperature

Each component can be further broken down into smaller steps, providing needed granularity. The HWS effectiveness score is calculated using the residuals of the expected versus the actual performance.

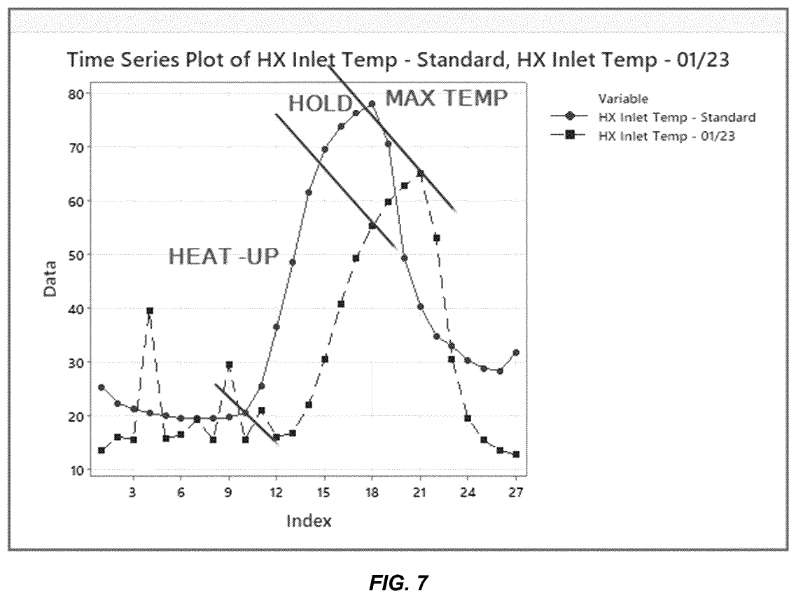

The graph in FIG. 7 is an example of data from which the HWS effectiveness score may be calculated. The chart shows time series data for the VRX heat exchanger inlet temperature. The graph includes two curves. The curve having circular data point indicators is the standard, or the expected performance. The curve having square data point indicators represents actual performance.

The three steps being evaluated are segregated by straight lines overlaid on the data curves. The sub-steps are heat-up, hold, and max temp.

The analysis would evaluate the following:
Heat-up: Residuals between the expected temperature and actual temperature.
Hold: Residuals between the expected temperature and actual temperatures. The temperature delta over time may be weighted.
Max Temp: There may an added weighted importance on final temperature expected versus actual.

The same analysis would be performed for components A through E listed above. Their combined scores would be calculated, totalled, and measured against a standard. A theoretical summary is provided below.

| COMPONENT | HEAT-UP | HOLD | MAX TEMP | TOTAL |
|---|---|---|---|---|
| HX Inlet | 20 | 10 | 25 | 55 |
| HX Outlet | 10 | 5 | 5 | 21 |
| RO FW Temp | −20 | −10 | −5 | −35 |
| RO Product | 5 | 20 | 5 | 30 |
| Temp | | | | |
| CDI Product | −1 | 0 | 0 | −1 |
| Temp | | | | |
| | | | TOTAL | 70 |

The final score would be evaluated based on a defined scale, which would ultimately provide an “Effectiveness Score.” An example of one possible solution is shown below.

| EFFECTIVENESS | NUMERIC |
|---|---|
| SCORE | RANGE |
| A | 0-20 |
| B | 21-40 |
| C | 41-60 |
| D | 61-80 |
| F | 80+ |

In the example above, the total sum of the values was 70, providing an Effectiveness Score of a “D.” The intelligence would not only provide a score but recommendations on how to improve it. For the example above, one recommendation could be, “Increase the HX inlet valve % open setting to allow more hot water to flow through.”

### Index Score

An index score utilizes a multi-variant regression analysis and advanced neural networks to predict the Total Organic Carbon (TOC) levels of the point of use water. That analysis is then simplified into a single score with associated process improvement recommendations. As noted above, the Hot Water Sanitizations Effectiveness Score may be one variable included in the regression analysis.

Process water treatment equipment produces time series data. Time series data is not a practical data source for machine learning tools such as Random Forest analysis. Random Forest analysis utilizes data that is more binary in nature, allowing multiple regression analysis to be performed, with the average of those analysis providing the final prediction. However, once the critical parameters have been determined using multi-variant regression, daily data could be averaged, allowing the use of a statistical analysis method such as, e.g., feature selection, which may improve model performance by reducing overfitting, making the inference more interpretable, and/or reducing data costs. However, determining the critical parameters via multi-variant regression (i.e., the largest coefficients) is typically constrained to only linear relationships. Thus, in some embodiments, it may be beneficial to determine the critical parameters for non-linear relationships using alternative methods such as, e.g., recursive feature elimination (RFE), data transformation into lasso (least absolute shrinkage and selection operator), etc.

Multi-variant regression is a much better initial tool for time series data by providing the following capabilities:
Output prediction. In this example, it is final point of use TOC.
Calculates and provides a weighted ranking of influence for the core inputs.
It finds the relation between the variables.
Finds correlation between independent and dependent variables.

For a water treatment system, some of the primary input variables that may be used are:
Feedwater conductivity
RO permeate conductivity
CDI permeate conductivity
HWS effectiveness score (numerical)
Recirculation flow
UV intensity
Loop return conductivity

Training data would be provided for a particular system with the intent to understand which variables have the best correlation to loop TOC values. Based on that analysis, certain input variables may be excluded to better improve the R² error, making the prediction more powerful.

Once the critical variables have been established, the on-going analysis would consist of daily averages of the time series data, analysed by a neural network. The output would be a predicted loop TOC value, which would then be translated into a score.

Below is a potential translation scorecard that could be used:

| Calculated TOC Value | | Index Score |
|---|---|---|
| <100 | ppb | A |
| 100-300 | ppb | B |
| 300-400 | ppb | C |
| >400 | ppb | D |

The program would display the index score to a user and also provide recommendations as how to improve the score.

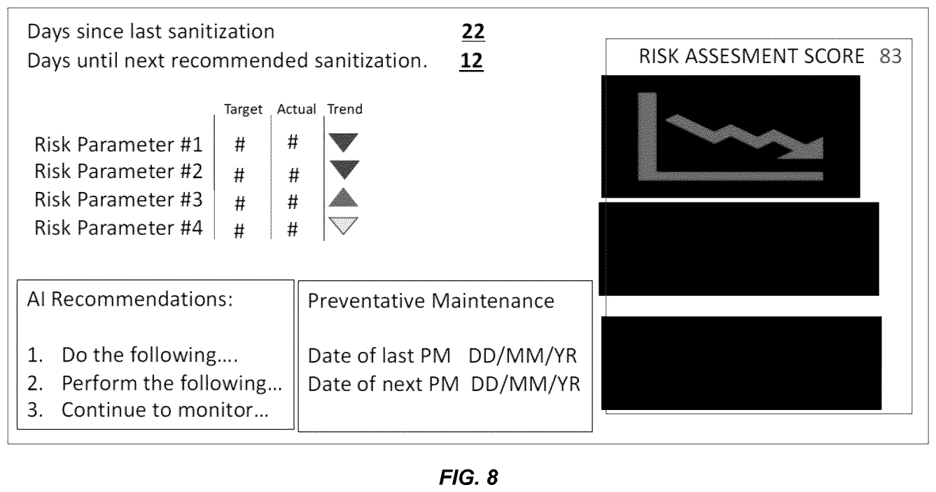

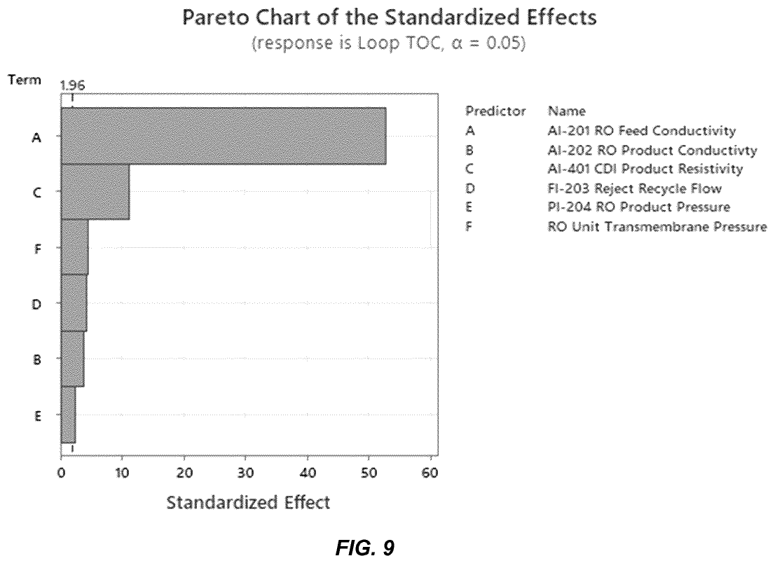

In some embodiments, the AI program may generate a user interface providing the determined risk assessment score and/or effectiveness index score and/or index score, a trend chart of one or more of these scores, a list of parameters from which one or more of the scores was derived and their associated values, targets, and trends, one or more recommendations for improving the operation of the water treatment system and other information, for example, an indication of the date preventative maintenance or sanitization was last performed and when the next preventative maintenance or sanitization should be performed. An example of this user interface is provided in FIG. 8. An additional example of a screen that would be accessible through the user interface and that indicates variables having the most impact on total organic carbon content (TOC) of treated water from a water treatment system with a confidence level of 95% (α=0.05) is shown in FIG. 9. As shown the conductivity of the feed into the RO unit of the water treatment system had the greatest impact on the TOC of the treated water.

In some embodiments, a score (e.g., a risk assessment score) may be used as an input during the training process. This integration enables models to dynamically adjust their parameters based on feedback generated by the artificial intelligence scoring mechanisms, thereby enhancing their ability to learn and adapt to changing conditions. For example, referring to FIG. 1, the risk assessment scores may be incorporated as an input with the third level data in order to train the artificial intelligence system.

One embodiment involves the recursive utilization of AI scoring within the training loop. During each iteration of the training process, the model receives input data along with corresponding AI scores generated by external scoring mechanisms. These scores reflect the model's performance on previous iterations or subsets of the dataset. By incorporating these scores as additional features, the model can effectively prioritize and weight its learning based on areas of improvement identified by the AI scoring mechanism. This recursive feedback loop facilitates continuous refinement of the model, leading to enhanced performance and generalization across diverse datasets.

Alternatively, in another embodiment, aspects of the present invention can be applied to unique model architectures designed to incorporate AI scoring as an intrinsic component. In this approach, the model is specifically engineered to receive AI scores (e.g., risk assessment scores) as input features, which are integrated into the learning process through specialized layers or modules. By directly incorporating AI scoring within the model architecture, rather than as an external feedback mechanism, this approach enables tighter integration and more efficient utilization of feedback information.

Aspects and embodiments disclosed herein also include methods of retrofitting an existing water treatment system to perform methods as disclosed herein. Retrofitting an existing water treatment system may include programming a controller, local and/or remote, of the water treatment system to perform an embodiment of the AI algorithm disclosed herein. Alternatively, a service provider may provide a customer with a non-transitory computer readable medium including instructions which when executed on a controller, local and/or remote, of the water treatment system to cause the wastewater treatment system to perform embodiments of the AI algorithm disclosed herein. A service provider may provide instructions, written, verbal, or in electronic form to a customer explaining how to operate the AI algorithm and how to interpret and react to its outputs.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A method of treating water in a water treatment system, the method comprising:
introducing water to be treated into the water treatment system to produce a defined quantity of treated water having defined quality metrics;
receiving data indicative of one or more operating parameters of one or more unit operations of the water treatment system;
determining a probability that the water treatment system will be able to produce and maintain production of treated water meeting the defined quality and the defined quantity metrics based on the received data;
generating a risk assessment score based on the probability; and
displaying the risk assessment score to a user.

2. The method of claim 1, further providing an indication of a confidence level of the risk assessment score.

3. The method of claim 2, wherein the confidence level is determined based on historical data regarding instances of the water treatment system providing treated water meeting or not meeting the defined quality and quantity metrics and levels of the one or more operating parameters at times of the instances.

4. The method of claim 1, further comprising providing a recommended action to take to mitigate a predicted change in quality of the treated water.

5. The method of claim 4, wherein the recommended action is based on historical data regarding instances of the water treatment system providing treated water meeting or not meeting the defined quality metrics, levels of the one or more operating parameters at times of the instances, and actions taken to bring the water treatment system into a condition in which it again provided treated water meeting the defined quality metrics.

6. The method of claim 1, further comprising providing a recommended action to improve the risk assessment score.

7. The method of claim 6, wherein an artificial intelligence system determines the recommended action based on historical data regarding instances of the water treatment system exhibiting the risk assessment score, levels of the one or more operating parameters at times of the instances, and actions taken to improve the risk assessment score.

8. The method of claim 6, wherein the artificial intelligence system further determines a recommended time to perform preventative maintenance on the water treatment system based on the data indicative of the one or more operating parameters and historical data regarding instances of the water treatment system providing treated water not meeting the defined quality metrics and levels of the one or more operating parameters at times of the instances.

9. The method of claim 6, wherein the artificial intelligence system further displays an indication of which of the one or more operating parameters are contributing to the risk assessment score being less than optimal.

10. The method of claim 6, further comprising using the risk assessment score as an input to train the artificial intelligence system.

11. The method of claim 6, further comprising incorporating the risk assessment score as an intrinsic component of a unique model architecture of the artificial intelligence system.

12. The method of claim 1, further comprising determining an effectiveness score for a preventative maintenance operation performed on the water treatment system and displays the effectiveness score to a user.

13. The method of claim 12, wherein an artificial intelligence system further determines actions that could be taken to improve the effectiveness score and displays the actions to the user.

14. The method of claim 13, wherein the artificial intelligence system further determines a potential overall impact of the actions to future effectiveness scores displays the overall impact to the user.

15. The method of claim 1, wherein an artificial intelligence system further determines an index score for the water treatment system based on at least the data indicative of the one or more operating parameters.

16. A non-transitory computer-readable medium comprising code executable on a computer to implement a method as recited in claim 1.

17. A water treatment system including a controller programmed to perform a method as recited in claim 1.
